(19) United States
(12) Patent Application Publication
(10) Pub. No.: US 2020/0375396 A1
(43) Pub. Date: Dec. 3, 2020

(54) FULL CYCLE SMOKE GENERATION IN PELLET BURNERS

(71) Applicant: W.C. BRADLEY CO., Columbus, GA (US)

(72) Inventors: RAMIN KHOSRAVI RAHMANI, Columbus, GA (US); ANTHONY HAMILTON, Hamilton, GA (US); MALLIK AHMED, Columbus, GA (US); Bruce Roberts, Phenix City, AL (US); SLEIMAN ABDALLAH, Columbus, GA (US)

(21) Appl. No.: 16/886,334

(22) Filed: May 28, 2020

Related U.S. Application Data
(60) Provisional application No. 62/853,337, filed on May 28, 2019.

(51) Int. Cl. A47J 37/07; A23B 4/044

(52) U.S. Cl. CPC A47J 37/0754; A47J 37/0704; A47J 37/0786; A23B 4/044

(57) ABSTRACT

A system includes a firepot within a cooking chamber, an auger that delivers pelletized fuel into the firepot, and a fan that provides combustion air to the cooking chamber. The fan operates on a periodic basis to maintain the cooking chamber in a state of high relative smoke generation compared to smoke generation that would occur in a steady-state fan operation.

### CROSS-REFERENCE TO RELATED CASES

This application claims the benefit of U.S. provisional patent application Ser. No. 62/853,337, filed on May 28, 2019, and incorporates such provisional application by reference into this disclosure as if fully set out at this point.

### FIELD OF THE INVENTION

This disclosure relates to smoking of food in general and, more particularly, to improved smoke generation in appliances utilizing solid pellet fuels.

### BACKGROUND OF THE INVENTION

Outdoor wood pellet fired cooking and smoking appliances have been used for some time (see, e.g., U.S. Pat. Nos. 4,823,684 and 5,251,607 to Joseph Traeger, et al.). Over the years there have been improvements and variations, but the essential principal of operation has remained the same. Wooden pellets are combusted with forced air to produce a hot and intense fire. The fire burns with very little smoke due the high temperatures and continual supply of excess air. It may be observed that the start-up condition of the pellet-burning products creates a considerable amount of smoke, as the heat is initially provided to the pellets surrounding an ignitor where limited oxygen is available. Such smoke production diminishes once the fire is fully developed.

Poorly designed or poorly functioning control systems in pellet fueled cooking devices can lead to excess fuel in the firepot, and the creation of a smothered and smoldering fire. This can lead to the undesirable buildup of exhaust gas with a considerable amount of unburned combustible material at a high temperature. This situation may lead to excessive implosive combustion. On the other hand, a certain amount of wood smoke is often considered desirable to add further flavor to the food being cooked.

What is needed is a system and method for addressing the above, and related, issues.

### SUMMARY OF THE INVENTION

The invention of the present disclosure, in one aspect thereof, comprises a system including a firepot within a cooking chamber, an auger that delivers pelletized fuel into the firepot, and a fan that provides combustion air to the cooking chamber. The fan operates on a periodic basis to maintain the cooking chamber in a state of high relative smoke generation compared to smoke generation that would occur in a steady-state fan operation.

In some embodiments, the fan operates on the periodic basis based on temperature of the firepot. In other cases the fan operates according to a predetermined schedule without regard to temperature of the firepot. The periodic basis of the fan may alter fan speed in a sinusoidal fashion or in a binary fashion corresponding to an open loop state and an off state.

In some embodiments, the auger operates on a periodic basis to deliver the pelletized fuel to the firepot. In other cases the periodic basis of the auger operation is based on a temperature of the firepot. The auger may also operate on a preprogrammed periodic basis without feedback based on temperature.

The invention of the present disclosure, in another aspect thereof, comprises a system having a cooking chamber having a firepot, an auger that periodically delivers pelletized fuel into the firepot, a fan that provides combustion air to the cooking chamber from outside the cooking chamber; and a controller having operative connections to activate and deactivate the auger and the fan. The controller operates the fan in a periodic fashion such that combustion within the firepot continually produces an increased amount of smoke compared to continual operation of the fan.

In some cases the fan is a single speed fan running on alternating current with the controller operating the fan in an on/off fashion. In other cases the fan is a variable speed fan, with the controller possibly operating the fan at a plurality of speeds. The controller may operate the fan such that a fan speed varies in a sinusoidal fashion.

The system can include a temperature probe in the firebox communicatively coupled to the controller. The controller may activate the fan when the temperature probe indicates a temperature in the firebox is below a first predetermined temperature and deactivate the fan when the temperature probe indicates the temperature in the firebox is above a second predetermined temperature. In some cases the controller is operatively connected to the auger and operates the auger on an intermittent basis to supply pelletized fuel into the firepot.

The invention of the present disclosure, in another aspect thereof, comprises a method including providing a cooking grill with a firepot providing smoke and heat to a cooking chamber, the firepot provided with fuel from an auger and combustion air from a fan, and operating at least the fan on a non-constant cycle so as to increase the amount of smoke produced from the cooking chamber relative to a full-time fan operation.

In some cases the fan is operated on a sinusoidal speed profile. In some cases the fan is operated in a stepwise function at a first speed over a first portion of a cooking cycle and being off over a second portion of the cooking cycle. The fan speed may be varied based upon a temperature measured inside with the cooking grill. The fan speed may be changed by a controller between an on speed and an off speed based on predetermined programming.

### BRIEF DESCRIPTION OF THE DRAWINGS

FIG. 1 is a perspective cutaway view of a pellet grill according to aspects of the present disclosure.

FIG. 2 is a schematic diagram of a pellet grill according to aspects of the present disclosure.

FIG. 3 is diagram of flow rate versus time for a pellet grill fan.

FIG. 4 is a diagram of flow rate versus time for a periodic fan in a pellet grill.

FIG. 5 is a diagram of flow rate versus time for an actively controlled period fan for use in a pellet grill according to aspects of the present disclosure.

### DETAILED DESCRIPTION OF THE PREFERRED EMBODIMENTS

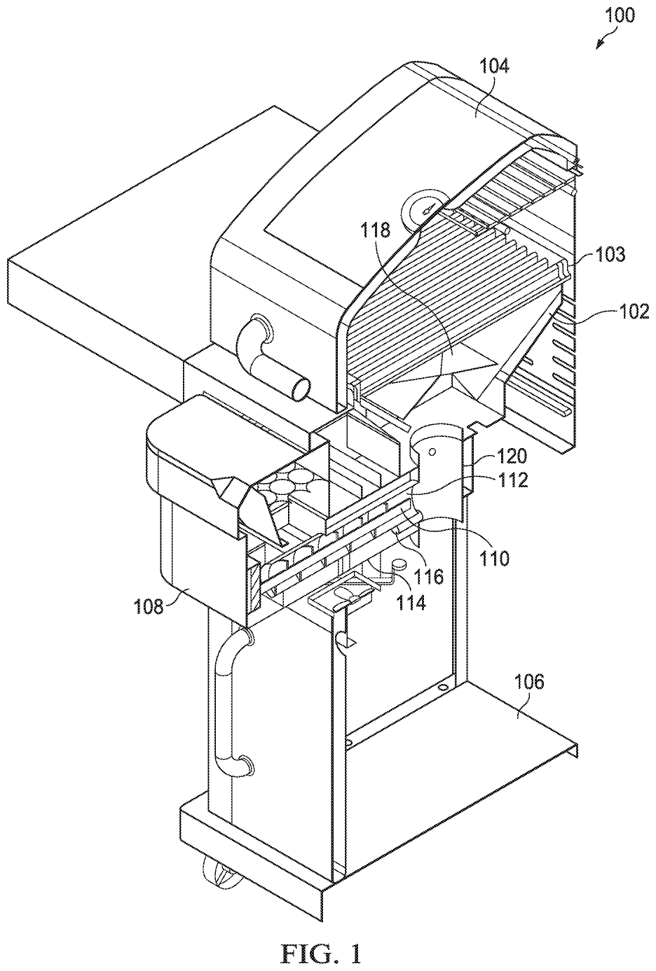

As shown in FIG. 1 in cutaway, a wood pellet cooking grill 100 provides a firebox or cooking chamber 102 containing or supporting a cooking grate 103. An openable or hinged lid 104 may be provided for selective access to the cooking grate 103. An electrically driven auger 110 may transport small compressed wood pellets or other pelletized fuel from an exterior hopper 108 to a typically open top cylindrical firepot or combustion chamber 120. The combustion chamber 120 may be supplied with combustion air pressurized and driven by an exterior fan through ductwork or a plenum 114 to an area surrounding the firepot 120 and then through holes in the exterior of the firepot feeding air into an inner combustion space. In some configurations, the auger 110 operates in an auger tube 112 that is at least partially inside the plenum 114.

An electric resistance igniter 116 may initiate combustion of the fuel inside the combustion chamber 120. Hot gas from the combustion chamber 120 may be conveyed through a series of baffles 118 to the cooking grate 103 placed above the combustion chamber 120. For purposes of the present disclosure, it should be understood that the cooking grill 100 is only exemplary, and that systems and methods of the present disclosure are adaptable to a wide variety of existing or forthcoming pellet grills or smokers.

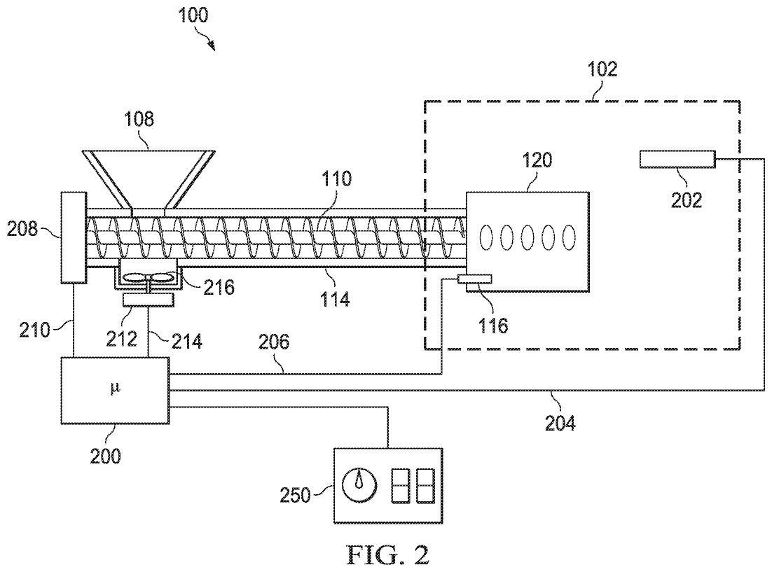

Referring now to FIG. 2, a schematic diagram of the cooking grill 100 is shown. The diagram of FIG. 2 is simplified in that not all components of the grill 100 are shown. Physically, the components may be arranged a number of ways as one of skill in the art will appreciate. The diagram of FIG. 1 is intended to facilitate ease of understanding of various control methods according to aspects of the present disclosure.

The grill 100 provides a controller 200, which may be a microcontroller or microchip-based implement. In another embodiment, the controller 200 comprises a number of integrated circuit or analog components to implement control methods according to aspects of the present disclosure. Control programs and other parameters may be provided by a user via a control panel 250, which may contain dials, switches, and indicators as are known in the art. In some embodiments, the control panel 250 and the controller 200 are integral and may be housed on or in a grill cabinet, hopper, or the like associated with the grill 100.

The microcontroller has an operative connection 210 to an electric motor 208 that provides motive force for the auger 110. The operative connection 210 may comprise electrical wiring, relays, and other implements as are known in the art to selectively connect the motor 208 to power for running the motor 208. In other embodiments the operative connection may comprise at least one wireless link to allow the controller 200 and/or control panel to activate the motor 208 remotely. Similarly, an operative connection 214 is provided to control operation of a motor 214 that drives a fan 216 that provides positive air pressure into the plenum 114. Again, this operative connection may comprise electrical wiring, relays, and other implements as are known in the art to selectively connect the motor 214 to power for running the motor 212, and may additionally, or instead, comprise a wireless connection. It should also be understood that, within the present disclosure, operation or activation of the fan 216 or auger 110 is by activation of the respective connected motor 212, 208 controlled by the controller 200.

The motors 208, 212 may be alternating current (A/C) motors or direct current (D/C) motors. A/C motors may be configured to operate with typical household outlet current, while D/C motors may be operable from battery power (internal or external to the grill 100) or with A/C current that has been rectified to D/C as is known in the art. The motors 208, 212 may be variable speed or single speed motors. In various embodiments systems and methods according to the present disclosure are operable with either type of motor.

The controller 200 may also have operative control over the ignitor 116 and is thus provided with operative connection 206. Operative connection 206 may once again comprise electrical wiring, relays, and other implements as are known in the art to selectively connect the motor ignitor 116 to a necessary power source to power it. In other embodiments the operative connection may comprise at least one wireless link.

In some embodiments, the operation of the grill 100 may be based, at least in part, on feedback from one or more temperature sensors at various locations. Here a temperature probe 202 may be situated within the cooking chamber 202 (for example, physically near the cooking grate 103). An operative connection 204 may be provided that allows the controller 200 to collect temperature data. Again, this may be a wired connection and/or wireless. It should also be understood that additional temperature probes may be present and that the probe 202 may be placed in a different physical location.

The control of the fire or combustion in the chamber 120 may be set by cycling the auger 110 on a time proportional basis driven by manual, thermostatic, or programmed inputs. In some embodiments, these are controlled by the controller 200, possibly based on program or other input selection from control panel 250. The fan 216 may be operated under prior methods at a constant and continuous fixed speed. In the case of various embodiments according to the present disclosure, the fan 216 is, instead, cycled on and off during a chosen cook cycle. Such cycles may be times so as to intermittently recreate what might be thought of as a start-up cycle of a pellet grill. In some embodiments, this results in a more or less continual production of smoke by the pellet fuel. Such an operational mode may be carried out at different auger 110 feed rates that create cooking chamber 102 temperatures of up to 300-350° F. Such cooking modes may be consistent with a long, slow smoking process found with solid fuel offset firebox smokers.

The fan 216 function may be driven by a target temperature (set point) and measured temperature (variable point), using a control method according to the present disclosure. This may include an active control that dictates the sequence and length of stages of pulsing, pausing, and continuous runs of the fan 216 and the specific pulsation function, frequency, and amplitude. The fan operation may be periodic or non-periodic based on the commands generated by the control system (e.g., controller 200) using values of set points and variable points. Where the fan 216 is of a constant speed type, the control of air flow may be in the nature of a step function between a running state and an off state. Stated another way the operation of the fan 216 may comprise an open loop operation with binary, on/off states only. Where the fan 216 is of a variable speed type, the variation in fan speed may be in the nature of a sinusoidal, ramped, or other type of other type of partial wave or full wave form.

It will also be appreciated that the fan 216 and auger 110 may be operated according to one or more predetermined operational modes that may not necessarily be active control measures. For example, one or more control methods may be implemented where the auger 110 runs a predetermined, possibly intermittent, period of time, or at a predetermined speed. The fan 216, in such case, may operate on a predetermined duty cycle. In such case, active control may not be employed, but rather one of a number of cycles or parameters that are known to reliably recreate a “startup sequence” in the firepot 120 for a substantial period of time that the control method is in effect.

It should be understood that, for purposes of the present disclosure, a “startup sequence” is a mode of operation of a pellet grill (e.g., grill 100) where a somewhat lower temperature, possibly incomplete, combustion of pellet fuel is beginning so as to produce more smoke than would normally be seen once the firepot 120 is up and running at full temperature.

Embodiments of the present disclosure create an increased amount of wood smoke during a continual cycle. In other words, throughout the entire cooking cycle, various methods and embodiments of the present disclosure produce a similar amount of smoke as a prior art device would only produce at startup. Because the fan 216 does intermittently cycle and can, over time, provide air flow required to create full combustion of pellets, a buildup of exhaust gas with unburned combustible material is avoided. Directing the fan to pulse, using different cycles, can lead to steady-state generation of the smoke with reasonably high intensity for a wide range of cooking temperatures.

A series of tests were performed to study the impact of fan pulsation showed that the smoke generation happens at least 75% (and up to more than 90%) of the run time for cooking temperatures up to 325° F. On the other hand, a constant-speed continuously run fan only generate smoke up to 40% (and as little as less than 10%) of the run time for cooking temperatures up to 250° F.

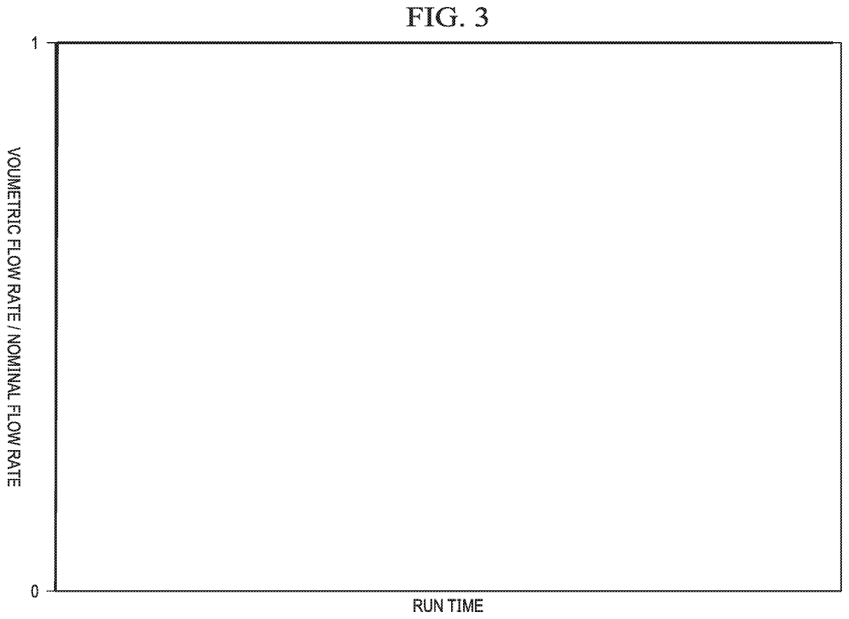

FIG. 3 is diagram of flow rate versus time for a pellet grill fan operated at a steady state. Here the vertical axis represents the volumetric flow divided by the nominal flow, with time on the horizontal axis. Here it can be seen that, with a steady-state single speed, a fan provides full flow rate into the plenum and firepot as soon as it is activated, and for as long as the cook cycle continues. Thus, combustion begins with a large amount of smoke, but quickly tapers off as combustion within the firepot reaches a level where smoke production is reduced

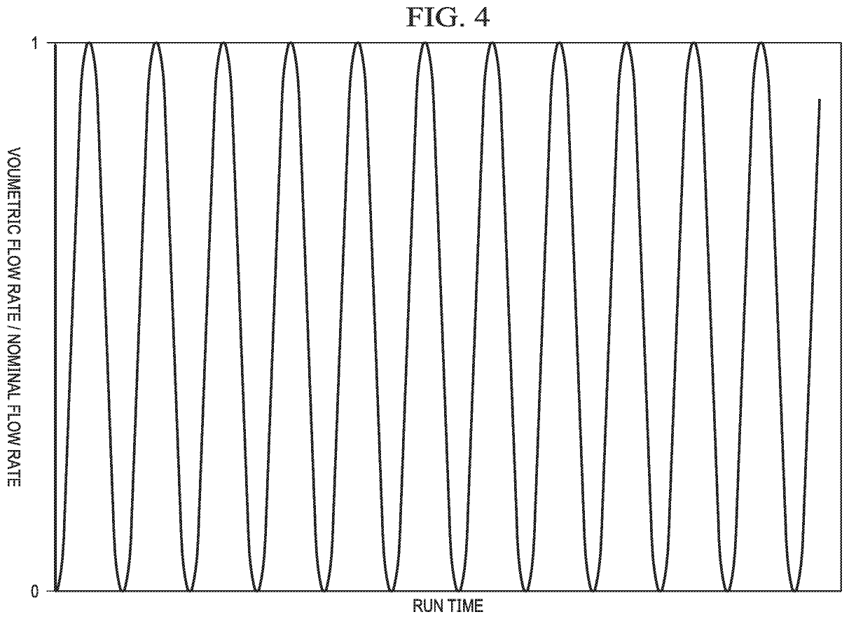

FIG. 4 is a diagram of flow rate versus time for a periodic fan 216 in the pellet grill 100. This operational mode, according to aspects of the present disclosure, shows that fan flow rate (vertical) is made to cycle over time (horizontal) in a periodic fashion. The fan speed is varied in a smooth curve approximating a sinusoid. Such fan control results in a greater overall percentage of smoke generation in a given cooking period, as discussed above. Since the amount of combustion air delivered to the plenum 114 and firepot 120 does not provide a continual stream of oxygen, the firepot 120 does not combust the pellets to the degree that smoke production is substantially eliminated over time as with a prior art system. However, over time, the fuel in the firepot is eventually substantially consumed, avoiding undesirable buildup of unburnt fuel and combustible gases within the firepot 120 and/or the cooking chamber 102 in general.

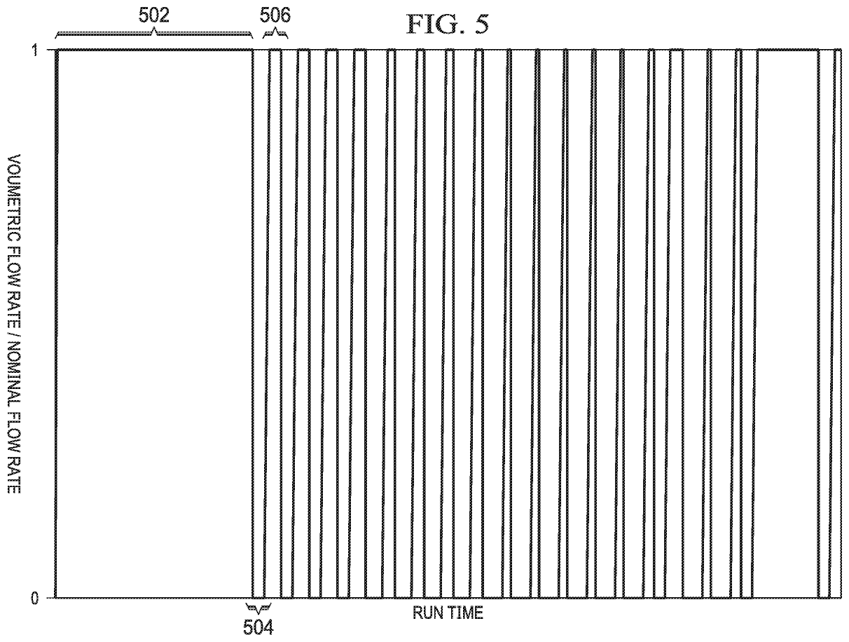

FIG. 5 is a diagram of flow rate versus time for an actively controlled periodic fan 216 for use in a pellet grill 100 according to aspects of the present disclosure. Here, again, with flow rate on the vertical and time on the horizontal, a longer fan run in an initial startup period 502 can be seen where the firepot 120 would be completely cold. Once the firepot 120 has heated beyond a smoke generation phase, the fan 216 may be stopped, either gradually or abruptly, and have a speed of zero. It should be understood that, although a single fan 216 is shown and described, that flow rates as in FIGS. 3-5 could be achieved by multiple fans as well. The controller 200 could selectively operate more or fewer of a plurality of fans (either steady state or variable speed) to achieve a desired flow rate according to methods and systems of the present disclosure.

Over some amount of time the firepot 120 and/or cooking chamber 102 cools, which can extend smoke production, but will eventually cool so far as to be ineffective for cooking or smoke generation. At this point, the fan 216 may be reactivated, possibly to a maximum flow rate 506, and possibly quite abruptly, approximating a step function. This second, and subsequent, cycle 506 may be shorter than the initial cycle 502 as the firepot 120 may not be allowed to cool completely. Hence it may more rapidly progress through a smoke generating phase and onward to a hotter phase where undesirably low quantities of smoke are produced. At this point, the fan may again be deactivated or slowed substantially, once again cooling the firepot and repeating some version of the afore described cycle.

As discussed above, an active control method may be based on, for example, temperature as sensed by a temperature probe 202 in the cooking chamber 202 and/or another location or from multiple or different temperature probes. Temperature having reached a set minimum, the fan 216 may be reactivated by the controller 200, along with the ignitor 116 if necessary, to increase combustion of the fuel in the firepot 120 until another high temperature set point is reached, at which point the fan 216 may be slowed or stopped. Since a control method may be based on active control by the controller 200 based, for example, on information from temperature probe 202, not every fan cycle is necessarily of the same duration as can be seen in FIG. 5.

Thus, the firepot 120 is continually operated within a temperature or combustion profile where a large amount of smoke is generated. As also discussed above, it has been shown that suitably high cooking temperatures can be maintained for adequately preparing food, even though the firepot 120 is rarely or never operating in a combustion state where smoke production is reduced to a level normally seen in steady state operations. The firepot 120 is maintained in a high smoke production mode that would normally only be seen at startup.

The auger 110 can be used to control the amount of fuel delivered to the firepot 120. The auger 110 may be operated intermittently at a constant speed, or, if the motor 208 is a variable speed motor, fuel delivery may be controlled at least in part by the auger 110 speed. The auger 110 may be used to control the total amount of fuel burned and, in some prior art devices, may be the only control provided over the combustion process. In embodiments according to the present disclosure though, operation of the auger 110 by the controller 200 may be taken into account along with the fan 216 operations previously described.

In some embodiments, the auger 110 is activated at startup to load the firepot 110 with an appropriate amount of fuel. The auger 110 may then be slowed or stopped while combustion begins. The auger 110 may be activated, or sped up if operating continuously, to deliver more fuel on a timed basis, based on temperature selection at the control panel 250, or based on information received by the microcontroller from the temperature probe 202, for example. Thus, the auger 110 may be operated according to a predetermined, and possibly user selectable, control method or by an active control method. Of course, at the conclusion of a cook cycle the auger 110 may be stopped completely and any fuel in the firepot 120 allowed to completely burn away.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A system comprising:
a firepot within a cooking chamber;
an auger that delivers pelletized fuel into the firepot; and
a fan that provides combustion air to the cooking chamber;
wherein the fan operates on a periodic basis to maintain the cooking chamber in a state of high relative smoke generation compared to smoke generation that would occur in a steady-state fan operation.

2. The system of claim 1, wherein the fan operates on the periodic basis based on temperature of the firepot.

3. The system of claim 1, wherein the fan operates according to a predetermined schedule without regard to temperature of the firepot.

4. The system of claim 1, wherein the periodic basis of the fan alters fan speed in a sinusoidal fashion.

5. The system of claim 1, wherein the periodic basis of the fan alters fan speed in a binary fashion corresponding to an open loop state and an off state.

6. The system of claim 1, wherein the auger operates on a periodic basis to deliver the pelletized fuel to the firepot.

7. The system of claim 6, wherein the periodic basis of the auger operation is based on a temperature of the firepot.

8. The system of any of claim 6 wherein the auger operates on a preprogrammed periodic basis without feedback based on temperature.

9. A system comprising:
a cooking chamber having a firepot;
an auger that periodically delivers pelletized fuel into the firepot; and
a fan that provides combustion air to the cooking chamber from outside the cooking chamber; and
a controller having operative connections to activate and deactivate the auger and the fan;
wherein the controller operates the fan in a periodic fashion such that combustion within the firepot continually produces an increased amount of smoke compared to continual operation of the fan.

10. The system of claim 9, wherein the fan is a single speed fan running on alternating current and the controller operates the fan in an on/off fashion.

11. The system of claim 9, wherein the fan is a variable speed fan.

12. The system of claim 11, where the controller operates the fan at a plurality of speeds.

13. The system of claim 11, wherein the controller operates the fan such that a fan speed varies in a sinusoidal fashion.

14. The system of claim 9, further comprising:
a temperature probe in the firebox communicatively coupled to the controller;
wherein the controller activates the fan when the temperature probe indicates a temperature in the firebox is below a first predetermined temperature and deactivates the fan when the temperature probe indicates the temperature in the firebox is above a second predetermined temperature.

15. The system of claim 14, wherein the controller is operative connected to the auger and operates the auger on an intermittent basis to supply pelletized fuel into the firepot.

16. A method comprising:
providing a cooking grill with a firepot providing smoke and heat to a cooking chamber, the firepot provided with fuel from an auger and combustion air from a fan; and
operating at least the fan on a non-constant cycle so as to increase the amount of smoke produced from the cooking chamber relative to a full-time fan operation.

17. The method of claim 16, wherein the fan is operated on a sinusoidal speed profile.

18. The method of claim 16, wherein the fan is operated in a stepwise function at first speed over a first portion of a cooking cycle and being off over a second portion of the cooking cycle.

19. The method of claim 16 wherein the fan speed is varied based upon a temperature measured inside with the cooking grill.

20. The method of claim 16 wherein the fan speed is changed by a controller between an on speed and an off speed based on predetermined programming.
